(19) United States
(12) Patent Application Publication
(10) Pub. No.: US 2014/0190623 A1
(43) Pub. Date: Jul. 10, 2014

(54) PROTECTIVE SAFETY WRAP FOR BASEBALL BAT

(71) Applicant: Major League Baseball, New York, NY (US)

(72) Inventors: Stephen Bradford, Los Angeles, CA (US); Tylor Garland, Los Angeles, CA (US); Matthew Paprocki, Los Angeles, CA (US)

(73) Assignee: Major League Baseball, New York, NY (US)

(21) Appl. No.: 14/048,915

(22) Filed: Oct. 8, 2013

Related U.S. Application Data
(60) Provisional application No. 61/749,763, filed on Jan. 7, 2013.

(51) Int. Cl. C09J 7/02; A63B 71/00; A63B 59/00

(52) U.S. Cl. CPC C09J 7/0264; A63B 59/0029; A63B 71/00
USPC 156/185; 428/343; 428/80; 428/157; 428/41.8

(57) ABSTRACT

A protective wrap for application to a wooden baseball bat to prevent the release of fragments should the baseball bat shatter during use is formed of an elongated piece of polymeric film that has a first end and an opposite second end, a first side edge, and an opposite second side edge. The piece has a first tapered region terminating at the first end and a second tapered region terminating in the second end. Within each of the first and second tapered regions, the first and second side edges converge. The piece also includes a main section located between the first and second tapered regions. The first and second side edges are parallel to one another along the length of the main section. A back surface of the polymeric film includes an adhesive for adhering the polymeric film to the baseball bat and to any underlying polymeric film.

### CROSS REFERENCE TO RELATED APPLICATION

The present application claims the benefit of U.S. patent application Ser. No. 61/749,763, filed Jan. 7, 2013, which is hereby incorporated by reference in its entirety.

### TECHNICAL FIELD

The present application is directed to a safety accessory for use with sports equipment and, more particularly, is directed to products and methods for preventing damage caused by breakage of athletic implements, such as wooden baseball bats.

### BACKGROUND

Sports equipment is a general term for any object used for sport or exercise. Sports equipment can be in the form of balls or the like, protective wear worn by a player and objects used by the player during play. Such objects, include but are not limited to: (1) racquets that are used for racquet sports, such as tennis, squash and badminton; and (2) sticks, bats and clubs (sticks are used for sports such as hockey and lacrosse; bats are used for sports such as a baseball and cricket; and clubs are used mainly for golf).

A number of these objects are typically formed of wood due to its strength, relative lightness and shock absorbing properties. However, it is known that wooden objects may fail if abused or overtaxed.

With respect to wooden baseball bats in particular, there is concern about the safety of on-field personnel and fans as a result of bats breaking into multiple pieces, otherwise known as multi-piece failures (MPFs). To date, significant research has been commissioned by Major League Baseball (MLB) to better understand and quantify the MPF problem via statistical analysis, numerical modeling, physical testing, and factory audits. Over the past few seasons, MLB has enacted various measures recommended by its consultants regarding quality control (QC) standards of solid wood bat manufacturing, with a resulting 50% decrease in MPFs across MLB.

Nevertheless, MLB is continuously working to improve safety for fans and on-field personnel. The present invention is directed at providing a potential solution to the continuing issue of MPFs among wooden baseball bats.

### SUMMARY

According to one embodiment, a protective wrap for application to a baseball bat to prevent the release of wooden fragments should the baseball bat shatter during use is formed of an elongated piece of polymeric film that has a first end and an opposite second end, a first side edge, and an opposite second side edge. The piece has a first tapered region terminating at the first end and a second tapered region terminating in the second end. Within each of the first and second tapered regions, the first and second side edges converge and wherein the piece includes a main section located between the first and second tapered regions. The first and second side edges are parallel to one another along the length of the main section. A back surface of the polymeric film includes an adhesive for adhering the polymeric film to the baseball bat and to any underlying polymeric film.

In another embodiment, a method for treating a wooden baseball bat to prevent the release of fragments should the baseball bat shatter during due includes the step of: wrapping an elongated piece of polymeric film around at least a transition portion of the baseball bat by wrapping, at a start location along the bat, in a spiral motion such that the polymeric film is wrapped completely around the bat to define an initial winding and then wrapping the polymeric film about the bat to form a series of successive windings with the polymeric film of each winding never completely overlapping an underlying winding and terminating the successive windings at an end location along the bat so as to form a two layer wrap around at least the transition portion of the baseball bat. The piece of polymeric film has a first side edge, an opposite second side edge, a first tapered region terminating at a first end thereof and a second tapered region terminating in an opposite second end thereof. Within each of the first and second tapered regions, the first and second side edges converge and the piece of polymeric film includes a main section located between the first and second tapered regions. The first and second side edges are parallel to one another along the length of the main section. In addition, the back surface includes an adhesive for adhering the polymeric film to the baseball bat and to any underlying winding of polymeric film.

### BRIEF DESCRIPTION OF THE DRAWING FIGURES

FIG. 1 is a perspective view of a baseball bat having a wrap in accordance with the present invention showing containment of an MPF;

FIG. 2 is a top plan view of a protective wrap in accordance with one embodiment of the present invention;

FIG. 3 is a side elevation view showing a first step in applying the protective wrap of FIG. 2 to a baseball bat;

FIG. 4 is a side elevation view showing a second step in applying the protective wrap of FIG. 2 to a baseball bat;

FIG. 5 is a side elevation view showing a third step in applying the protective wrap of FIG. 2 to a baseball bat; and

FIG. 6 is a side perspective view of a dispenser containing one or more protective wraps.

### DETAILED DESCRIPTION OF CERTAIN EMBODIMENTS

The present invention is directed to a protective wrap (tape) for use with a wooden athletic implement, such as a baseball bat. While the figures depict the use of the protective wrap on a baseball bat, it will be understood that the protective wrap can be applied to other wooden athletic implements, such as a hockey stick, for completely retaining wood fragments should the wooden athletic implement shatter during use. In addition, the protective wrap and method for applying the protective wrap to a wooden implement (baseball bat) not only reduce the likelihood of damage from shattering of the wooden implement but also do not significantly alter the performance characteristics of the wooden implements. More specifically, the protective wraps of the present invention comply with current MLB governing rules.

As is well known, a baseball bat has a specific shape intended to efficiently strike and drive a baseball. The bat is circular in cross-section and is divided into several regions. The thickest part of the bat, the region where the bat is meant to impact the ball, is known as the barrel. The barrel ends at one end in a generally rounded or concave tip. The portion of the barrel intended to interact with the ball is usually called the sweet spot. Below the sweet spot (opposite the tip) the barrel narrows and becomes the handle. Compared to the barrel, the handle is thin, to accommodate the batter's grip. At the end of the bat proximate the handle is a knob (a widening of the handle) to prevent the bat from sliding out of the batter's grip.

Historically, most wooden bats were made from ash. Other varieties of wood, however, have also been used to make bats, including maple and hickory. Hickory has fallen into disfavor over its greater weight, which slows down bat speed, while maple bats gained popularity following the introduction of the first major league sanctioned model in 1997. However, recently MLB has examined the use of maple bats as a result of maple bats having an increased tendency to shatter compared to ash bats and others.

The present invention offers a simple yet highly effective method for reducing the damage from shattered bats. In particular, and in accordance with the present invention, a very thin but durable polymeric film is applied to the exterior surface of the wooden bat. As set forth in greater detail below, there are a number of different polymeric films that are suitable for the intended application. The polymeric films are thin (e.g., between about 2 mil (2 thousandths of an inch or 0.051 mm) to 20 mil (20 thousandths of an inch or 0.51 mm)) so that it has negligible weight and little if any effect on the bat's operation.

With respect to baseball bat applications, the present invention is thus the result of efforts to develop a bat wrap solution that will significantly reduce the remaining safety hazards associated with MPFs in a non-invasive, cost-effective manner that will be embraced by players and fans alike.

Suitable Materials

Based on extensive research the inventors have gained a thorough understanding of the intricacies involved in applying a thin film wrap to a bat in a manner that will contain MPFs without substantively changing the physical specifications or performance characteristics. The material that forms the wrap of the present invention has been evaluated with respect to:
a. Sufficient strength and tear resistance per specifications
b. Adhesive strength and compatibility with wooden substrates
c. Shelf life
d. UV resistance
e. Temperature and humidity response profiles
f. Tactile qualities
g. Appearance (transparency)
h. Preliminary evaluation for ease of application by bat manufacturers
i. Potential implementation scenarios
j. Approximate cost
k. Affects on bat performance (quantified through dowel impact bending tests)

There are a number of different materials that are commercially available and marketed as being strong polymer films that can be applied to any number of different types of objects depending upon the precise application. For example, suitable films are available and are commercially sold as paint protective films for use on vehicles. Suitable paint protective films include but are not limited to Scotchgard™ Paint Protective Films or XPEL Paint Protective Films. These protective films are designed to be applied to protect automotive and other painted surfaces from impact damage or stains. These polymeric films have high tensile strength which lends itself to retaining the fragments of a shattered bat. These films can be made from a number of different polymeric materials and most often are formed of aliphatic polyurethane; however, other suitable polymeric materials include polyester (e.g., polyethylene terephthalate), polyethylene, polypropylene, polyamide (e.g., nylon), etc. These films are typically supplied with an adhesive coating affording ready application to a clean surface; however, it is also possible to apply adhesives to the film immediately prior to or during the process of applying the film to the bat.

It will also be appreciated that the lightweight and transparency of the film also the film to be applied to select portions or even be applied to essentially the entire exterior surface of the baseball bat. However, as described below, the thinner handle portion of the bat is far more likely to fail and, therefore, this region should be covered with the polymeric film. It is likely that most players prefer to have the sweet spot uncovered and, therefore, this portion of the bat is the least likely to be covered with the polymeric film. However, it will be understood that the protective film of the present invention can be applied to any portion of the bat.

Additional properties and characteristics of suitable materials are set forth in U.S. Pat. No. 8,241,155, which is hereby incorporated by reference in its entirety.

After extensive testing with respect to the wrap construction described below, the present Applicant found that the following four wrap material yielded superior results compared to other materials tested by the Applicant: (1) a 3M thin polymer film marketed under the trade number 471; (2) a 3M thin polymer film marketed under the trade name Scotchgard Paint Protection Film SGH6; (3) a 3M thin polymer film marketed under the trade name Scotchgard Paint Protection Film SGH12; and (4) 2:1 polyolefin heat shrink. Applicant extensively tested there materials in varying forms (widths and shapes) and the analysis (testing) was concerned not only with the specifications and performance but also the weight, appearance, cost, and ease of application. Based on the test results, Applicant discovered that the 3M Scotchgard Paint Protection Film SGH6 applied as a 1″ tape wrap provided optimal results.

Wrap Construction

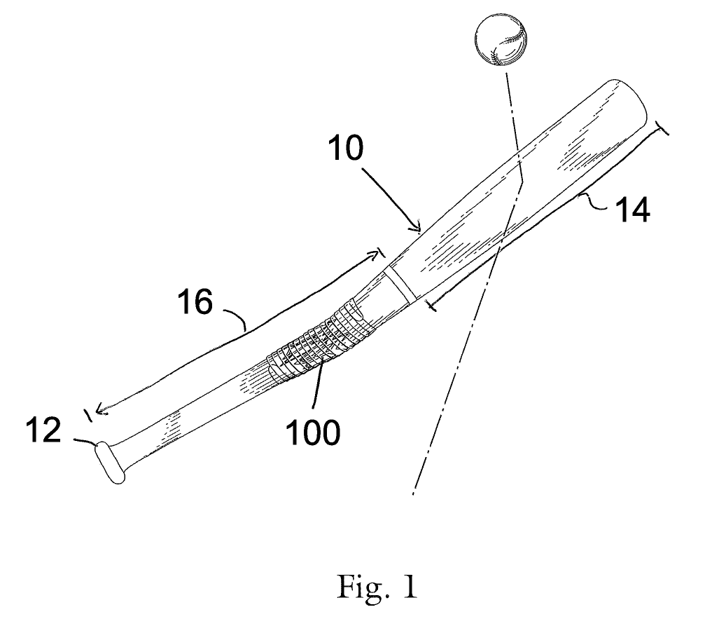

FIG. 1 is a perspective view of a regulation baseball bat 10 wrapped with a protective wrap 100 applied to one or more sections (portions) of the bat 10. The bat 10 includes a handle 12; a barrel 14; and a transition zone 16 that is between the handle region 12 and the barrel region 14. According to current MLB rules, handle and transition zone 16 have a maximum length of 18 inches, while the barrel 14 varies between 29 and 35 inches.

In the embodiment shown in FIG. 1, the protective wrap 100 is applied to a portion of the transition region 16 between the handle 12 and the barrel 14. A substantial amount, if not all, of the barrel 14 is left uncovered. It will be appreciated by one of skill in the art that given the product nature and the manner of applying the wrap 100 to the bat 10, the precise structure of the wrap 100 is adaptable to meet various rules and regulations. For example, MLB Rule 1.10(c) states that: “it is not allowed to have a foreign substance on the bat more than 18 inches up from the bottom handle . . . ” The protective wrap 100 shown in FIG. 1 fully complies with this rule since not only the length of the applied protective wrap 100 can be selected and customized but also the location along the bat 10 at which the protective wrap 100 is applied can be selected. It will be appreciated that such polymeric films are typically supplied in sheet form and then, subsequently, the film is cut according to a precise shape and according to selected specifications (dimensions) to form the protective wrap 100. Any number of conventional techniques (including those used in the paint protection film field) can be used to cut the polymeric sheet and form the protective wrap 100. For example, the polymeric film can be cut to shape using a plotter. As mentioned herein, preferred polymeric films comes with an adhesive layer disposed on a backside (surface) of the film, with a protective release layer (backing) covering the adhesive layer prior to use. The backing is subsequently peeled off at the time of application and the protective film is applied to the bat in the manner described herein. It will be appreciated that heat can be applied to improve the contact of the film. In addition, while clear films are preferred in many applications, it is equally possible for the film to have one or more colors and further, to have indicia formed thereon.

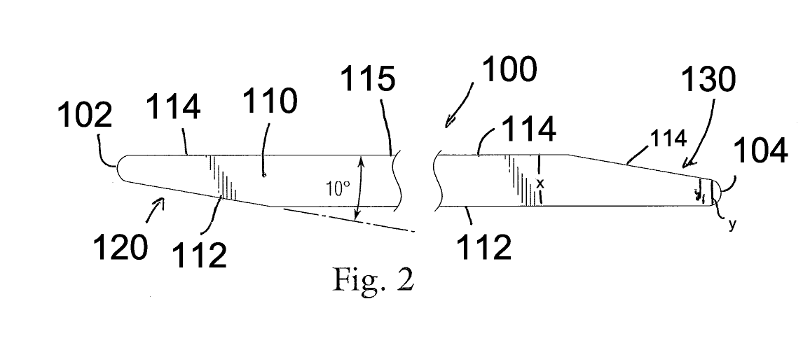

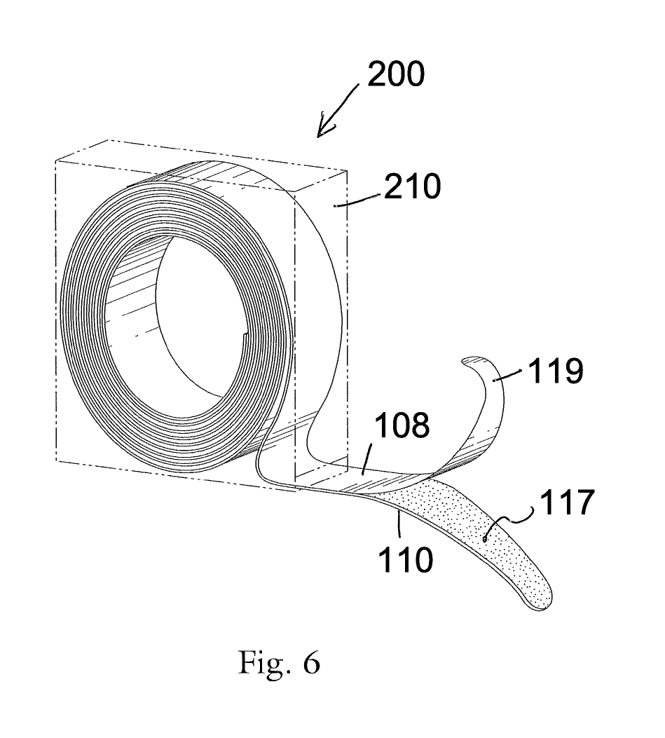

One exemplary protective wrap 100 in accordance with the present invention is illustrated in FIG. 2. As described herein, the protective wrap 100 is a dual taper bat wrap that has a first end 102 and an opposite second end 104. As shown, the first and second ends 102, 104 can be in the form of rounded ends as illustrated in FIG. 2 as opposed to straight edges. However, other constructions for the ends 102, 104 are equally possible. In one embodiment, the rounded end is defined by a radius of about 0.25 inches. The protective wrap 100 has a first surface or face (back) 108 (FIG. 6) and a second surface of face (front) 110. The protective wrap 100 is defined by a first side edge 112 and an opposite second side edge 114. For ease of illustration, the protective wrap 100 is shown with break lines as a result of its considerable length.

As shown in FIG. 6, an adhesive layer 117 is disposed on a backside (surface) of the film, with a protective release layer 119 (backing) covering the adhesive layer prior to use.

As a result of its dual taper construction, the protective wrap 100 thus has a first tapered region 120 at the first end 102 and a second tapered region 130 at the second end 104. Each of the tapered regions 120, 130 is defined by areas in which the first and second side edges 112, 114 are not parallel to one another. More specifically, each of the first and second tapered regions 120, 130 have an inwardly tapered construction in that the first and second side edges 112, 114 converge toward one another. In the illustrated embodiment of FIG. 2, the first and second side edges 112, 114 do not meet one another to form a pointed end. Instead each of the first and second ends 102, 104 has a smooth, rounded construction. In addition, in the embodiment of FIG. 2, one of the side edges 112, 114 for each of the first and second tapered is a straight edge, while the other of the side edges 112, 114 is a beveled edge.

In addition, as will be appreciated in view of FIG. 2, the first and second tapered regions 120, 130 are not mirror images of one another in that the tapered walls are opposite. In the first tapered region 120, the first side edge 112 represents the beveled edge, while the second side edge 114 represents the straight edge. In contrast, in the second tapered region 130, the second side edge 114 represents the tapered edge, while the first side edge 112 represents the straight edge.

In one embodiment, the angle of the taper within the first and second tapered regions 120, 130 is about 10 degrees. In other words, an angle of 10 degrees is formed between the tapered side edge and the straight edge as shown in FIG. 2. While in a preferred embodiment, the angle of taper is the same for both the first tapered region 120 and the second tapered region 130, it will be appreciated that the angle of taper can be different in some applications.

It will be appreciated that the length of the protective wrap 100 (when it is in flat form) is selected in view of the specific application and in particular, depends on the dimensions of the bat 10 and also on the selected degree of coverage along the bat 10. In one embodiment intended for application on a regulation MLB bat, the protective wrap 100 has a length of about 56.50 inches from the first 102 to the second end 104. The width of the protective wrap 100 at its maximum width (x) can be about 1.00 inches. As mentioned herein, the protective wrap 100 has a dual taper defined by first and second tapered regions 120, 130 and thus, in these regions, the first and second side edges 112, 114 are not parallel to one another. In contrast, the first and second side edges 112, 114 are parallel to one another along a main section 115 of the protective wrap 100. In one embodiment, the length of the main section 115 is about 49.50. A minimum width (y) of the wrap as measured in the tapered regions can be about 0.50 inches.

It will also be appreciated that the length of the first and second tapered regions 120, 130 can be the same or can be different in that one of the tapered regions 120, 130 can have a greater or lesser length compared to the other region. In one embodiment, at least one of the first and second tapered regions 120, 130 as a length of about 3.06 inches as measured from: (a) the point at which one side edges begins to converge to the other to (b) the respective end.

Based on extensive research, the design of the bat wrap 100 of the present invention was optimized to further reduce weight and increase durability while simplifying conversion and application. The dual tapers (first and second tapered regions 120, 130) at the beginning and end of the strip include fillets, as noted above, to further simplify the wrapping process and increase durability (no sharp edges to catch on). Compared to other options, the present approach is simpler to apply, lighter, has a lower material cost, and provides a nicer finished product.

While others have taught the application of a shrink-wrap like material or a monolithic sheath or sleeve-like structure to a baseball bat, the present Applicant has discovered that superior results are obtain when a smaller width tape is used (having the above construction) and is applied as a wrap defined by a number of windings along the length of the wrap as described below.

Custom Spiral Bat Wrap Installation Procedure

Described below is one exemplary manual installation procedure that can be used for wrapping bat 10 with the protective wrap 100. A more standardized process and tooling can be provided for large-scale production. In other words, it is within the scope of the present invention that the bat wrapping installation process can be automated using conventional equipments and computer control, etc. and is not limited to a manual wrapping process.

As shown in FIG. 3, the bat 10 is placed horizontally on a support surface (table or the like) with the knob (handle) 12 on the left and the barrel 14 on the right. Using a measuring device 13 (e.g., measuring tape, etc.), small markings (a, b) are made at a first location and a second location which is spaced from the first location. The first and second locations define the wrap zone in which the protective wrap 100 is applied since the two marks define the beginning and end of the wrap zone. In one example, the marks can be at 10″ and at 18″ from the knob end 12 of the bat 10 (thereby creating a wrap zone having a length of about 8 inches).

Next, the protective wrap 100 is positioned such that the tapered edge 112 of the first tapered region 120 is aligned with the first marking (10″ mark) and thus faces to the left. Conversely, the straight edge 114 of the first tapered region 120 is located on and faces to the right and the rest of the protective wrap 100 angles to the right away from the bat 10 as shown.

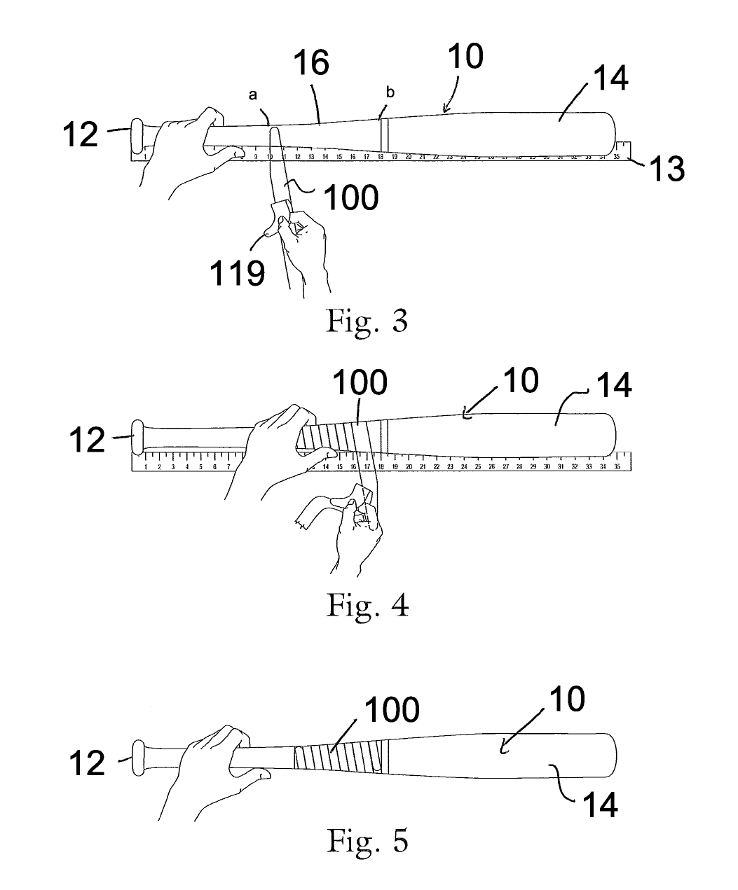

The protective wrap 100 is held with the backing (protective release layer) still attached and is kept under slight tension. Excessive tension should be avoided since it can overly stretch the protective wrap 100 along its length and result in the wrap 100 have too long a length. Next, with the left hand edges (edge 112) carefully aligned, the protective wrap 100 is wrapped once around the bat 10 as shown in FIG. 4. The taper is specifically designed such that it will line up properly after one revolution and then automatically angle the rest of the wrap to achieve a 50% overlap (between adjacent windings). It will be appreciated that a different percentage of overlap can be chosen and implemented using a properly shaped, cut protective wrap 100. The aforementioned alignment of the windings is followed to ensure the proper overlap, making sure that the new wrap (new winding) does not overlap too far to the left as this creates a noticeable step between the windings (e.g., creation of 3 layers vs. intended 2 layers).

The protective wrap 100 is continuously wound about the bat 100 with the above-described 50% overlap all the way up to second marking (the mark 18″ from the knob) where there is a pre-cut taper (the second tapered region 130) that aligns nicely with the previous layers (windings). As shown in FIG. 5, this wrapping process results in a nice clean edge being created at the second marking (the 18″ mark) and that the protective wrap 100 is not more than two layers thick along its length.

It will be appreciated that slight trimming may be necessary depending on the bat profile and tension used during application.

The rounded ends 102, 104 of the dual tapered protective wrap 100 are thus located in non-overlapping manner in the final applied wrap. In other words, one rounded end 102 of the wrap 100 is at the 10″ line in the above example, while the other rounded end 104 of the wrap 100 is at the 18″ line in the above example.

It will be appreciated that the above process is merely one exemplary way of applying the wrap of the present invention.

It is also apparent to one of ordinary skill that the wrap of the present invention is adaptable to meet various rules and regulations. For example, Major League Baseball Rule 1.10(c) states: “it is not allowed to have a foreign substance on the bat more than 18 inches up from the bottom handle . . . .” Players might object to having the film prevent their hand from actually touching the wooden grip of the bat. Thus, the Major League Baseball configuration can be constructed such that the film does not cover the lower 3 or 4 inches of the bat, leaving the bottom end of the bat uncovered so that the player's hands directly grip the wooden surface of the bat.

The protective wraps 100 of the present invention were found to not adversely impact the performance of the bat itself. In particular, the ball exit speed ration (BESR) and the batted-ball speed (BBS) were identified for the sweet-spot location for a bat wrapped with wrap 100 and one containing no wrap and both bats have very similar performance. Thus, the wrapped bat yielded no performance advantage over the traditional bat (e.g., solid-ash bat).

Now turning to FIG. 6, the protective wrap 100 can be provided to a user in any number of different ways. For example, a plurality of cut protective wraps 100 can be provided in a stacked sheet form or alternatively, in order to minimize space and reduce transportation charges, the protective wraps 100 can be supplied as rolls.

FIG. 6 shows a dispenser or package 200 for holding one or more protective wraps 100 and maintaining them in a rolled form. The dispenser/package 200 includes a hollow housing or casing 210 that is sized to contain one or more wraps 100 in rolled form. In the case of a single wrap, the casing 210 can be in the form of a box made from paper (similar to a box of office tape). The protective wrap 100 is rolled after it has been cut to its desired shape and as shown in FIG. 6, the wrap 100 includes backing layer 119 (protective release layer) that covers adhesive layer 117.

It will also be appreciated that while the dispenser 200 of FIG. 6 shows only one protective wrap 100 being contained therein, more than one wrap 100 can be contained therein, with the plural wraps 100 being in series with one another. Also, the wrap(s) 100 can be wound about a core, such as a plastic core (not shown) and contained within packaging, such as a box made of a suitable material, such as paper. In the case of multiple wraps 100 being contained within one dispenser 200, the wraps 100 can be contained in a box which can include a slot or the like through which the wrap 100 can pass through for removal from the dispenser 200.

In addition, when creating a series of wraps 100, the individual wraps 100 can be releasably joined end-to-end as by using a small piece of adhesive tape between the adjacent ends. For example, the second end 104 of one wrap 100 can be joined to the first end 102 of the next wrap 100 to allow wraps 100 to be removed from the dispenser in succession.

### Example

In one embodiment, the protective baseball wrap 100 of the present invention is made out of 3M Scotchgard Paint Protection Film SGH6 (the “SGH6 film”) and has the shape and dimensions discussed above with respect to FIG. 2. The following table sets forth the material properties of the SGH6 film.

| | |
|---|---|
| Backing | Thermoplastic Urethane with Protective |
| | Clear Coat |
| Adhesive type | Acrylic |
| Reinforcement | None |
| Adhesion to Steel (oz./in. width) | 64 |
| (D-3330) | |
| Tensile Strength | 1740 PSI (different test procedure than |
| | tapes) |
| % Elongation at Break (D-3759) | 200 |
| Total Thickness (mil) (D-3652) | 6 (film) + 2 (adhesive) = 8 (total) |
| Standard Widths (mm) | 10, 50, 100, 150, 300 |
| | Also available in sheets (max width |
| | 48″) |
| Standard Lengths (m) | 84″, 10 yds, 40 yds |
| Shelf life (months) | 12 |
| UV resistance | Very good |
| Temperature and humidity range | Up to 158° F. and 100% RH |

The present invention greatly reduces the likelihood of flying fragments from a baseball bat that breaks during use. At least a portion of is wrapped with a polymeric film, such as the ones listed herein. In one embodiment, for a standard professional sized bat, the polymeric film is applied as a wrap in a zone that is generally located 10″-18″ from the knob of the bat. As mentioned herein, a zone extending between 10″-18″ provides one exemplary wrap zone coverage and is not limiting of the present invention. The wrap zone coverage can be less than or greater the above coverage and/or can start and end at different locations along the bat depending upon the particular application.

While the dual tapered wrap 100 of the present invention has been described with reference to being applied to baseball bat 10, it will be understood that it can be applied to other sporting goods made of wood, such a hockey stick, etc., that are prone to breakage during use.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A protective wrap for application to a wooden baseball bat to prevent the release of fragments should the baseball bat shatter during use comprising:
an elongated piece of polymeric film that has a first end and an opposite second end, a front surface, an opposite back surface, a first side edge, and an opposite second side edge, the piece having a first tapered region terminating at the first end and a second tapered region terminating in the second end, wherein within each of the first and second tapered regions, the first and second side edges converge and wherein the piece includes a main section located between the first and second tapered regions and the first and second side edges are parallel to one another along the length of the main section; and
wherein the back surface includes an adhesive for adhering the polymeric film to the baseball bat and to any underlying polymeric film.

2. The protective wrap of claim 1, wherein each of the first and second ends comprises a rounded end.

3. The protective wrap of claim 1, wherein within the first tapered region, the first side edge comprises a beveled edge and the second side edge comprises a straight edge that extends the length of the main section; and wherein within the second tapered region, the first side edge comprises a straight edge that extends the length of the main section and the second side edge comprises a beveled edge.

4. The protective wrap of claim 1, wherein the piece has a maximum thickness in the main section and a minimum thickness in the first and second tapered regions, the minimum thickness being 50% or less of the maximum thickness.

5. The protective wrap of claim 4, wherein the maximum thickness is about 1 inch and the minimum thickness is about 0.5 inch.

6. The protective wrap of claim 1, wherein the polymeric film is formed from polymers selected from the group consisting of polyurethanes, polyesters, polyethylenes, polypropylenes and polyamides.

7. The protective wrap of claim 1, wherein an angle defined between the first and second side edges within at least one of the first and second tapered regions comprises about 10 degrees.

8. The protective wrap of claim 1, wherein the adhesive layer is pre-applied to the back surface and includes a removable protective release covering the adhesive layer and the polymeric film is of a type that allows the piece to be rolled.

9. The protective wrap of claim 1, wherein the piece has symmetry about a central longitudinal axis that extends the length of the piece but has asymmetry about a central transverse axis that extends between the first and second side edges at a midpoint of the piece.

10. A method for treating a wooden baseball bat to prevent the release of fragments should the baseball bat shatter during due comprising the step of:
wrapping an elongated piece of polymeric film around at least a transition portion of the baseball bat by wrapping, at a start location along the bat, in a spiral motion such that the polymeric film is wrapped completely around the bat to define an initial winding and then wrapping the polymeric film about the bat to form a series of successive windings with the polymeric film of each winding never completely overlapping an underlying winding and terminating the successive windings at an end location along the bat so as to form a two layer wrap around at least the transition portion of the baseball bat, wherein the piece has a first side edge, an opposite second side edge, a first tapered region terminating at a first end thereof and a second tapered region terminating in an opposite second end thereof, wherein within each of the first and second tapered regions, the first and second side edges converge and wherein the piece includes a main section located between the first and second tapered regions and the first and second side edges are parallel to one another along the length of the main section, and wherein the back surface includes an adhesive for adhering the polymeric film to the baseball bat and to any underlying winding of polymeric film.

11. The method of claim 10, wherein each of the first and second ends comprises a rounded end.

12. The method of claim 10, wherein within the first tapered region, the first side edge comprises a beveled edge and the second side edge comprises a straight edge that extends the length of the main section; and wherein within the second tapered region, the first side edge comprises a straight edge that extends the length of the main section and the second side edge comprises a beveled edge.

13. The method of claim 12, wherein the polymeric film is positioned relative to the baseball bat such that the first side edge of the first tapered region is located on the left and is aligned with a first locating mark formed at the first location, the first tapered region being constructed such that the polymeric film lines up properly after one revolution about the bat, which forms the initial winding, and then automatically angles a remaining length of the polymeric film to achieve an about 50% overlap.

14. The method of claim 13, wherein the first locating mark is a line that is perpendicular to a central longitudinal axis of the baseball bat that extends along a length thereof.

15. The method of claim 10, wherein the polymeric film of each successive winding overlaps the underlying winding by about 50%.

16. The method of claim 10, wherein the first end of the polymeric film is disposed at the first location and the second end of the polymeric film is disposed at the second location.

17. The method of claim 12, wherein a first end of the two layer wrap is defined by the beveled first side edge of the first tapered region and an opposite second end of the two layer wrap is defined by the beveled second side edge of the second tapered region.

18. The method of claim 10, wherein the piece of polymeric film has symmetry about a central longitudinal axis that extends the length of the piece but has asymmetry about a central transverse axis that extends between the first and second side edges at a midpoint of the piece.

19. The method of claim 10, wherein a barrel portion of the bat remains uncovered by the polymeric film.
